(19) United States
(12) Patent Application Publication
(10) Pub. No.: US 2015/0072559 A1
(43) Pub. Date: Mar. 12, 2015

(54) ELECTRICAL CONNECTOR FEATURED WITH ADDITIONAL CONTACTS FOR RADIO FREQUENCY SIGNAL TRANSMISSION

(71) Applicant: HON HAI PRECISION INDUSTRY CO., LTD., New Taipei (TW)

(72) Inventors: QIU QIAN, Kunshan (CN); JIAN-KUANG ZHU, Kunshan (CN); CHUN-SHENG LI, Kunshan (CN)

(21) Appl. No.: 14/474,182

(22) Filed: Sep. 1, 2014

(30) Foreign Application Priority Data
Sep. 9, 2013 (CN) 2013205538350

(51) Int. Cl. H01R 13/6582; H01R 13/58; H01R 13/46

(52) U.S. Cl. CPC H01R 13/6582; H01R 13/46; H01R 13/58
USPC 439/607.17; 439/607.01

(57) ABSTRACT

An electrical connector includes a mating tongue defining opposite upper and lower long mating faces and a side mating face, and a plurality of first contacts retained in the mating tongue. The mating tongue retains a first outer contact and a first inner contact therein, the first inner contact defines a contacting portion exposed upon the side mating face, and the first outer contact defines two bending portions respectively exposed upon the upper and lower long mating faces and a first connecting portion connecting with the two bending portions, the first inner contact is disposed among the two bending portions and the first connecting portion to be surrounded on three sides by the first outer contact.

### BACKGROUND OF THE INVENTION

1. Field of the Invention

The present invention relates to an electrical connector, and more particular to an electrical connector having additional contacts for RF (Radio Frequency) signal transmission.

2. Description of the Related Art

Taiwan Pat. No. 1287324 issued on Sep. 21, 2007 discloses an electrical connector assembly including a first connector and a second connector mating with each other. The first and second connectors each defines two different interfaces arranged side by side and spaced from each other along a longitudinal direction, which makes different connector interfaces combo in one connector for expediently using. However, the two different interfaces in each connector are conventional types and are simply arranged in a side by side manner along the longitudinal direction, which may increase the length of the first and second connectors and is not benefit for miniaturization.

Therefore, a new design is required.

### SUMMARY OF THE INVENTION

Accordingly, an object of the present invention is to provide an electrical connector featured with additional contacts in a normal interface for miniaturization.

In order to achieve the object set forth, an electrical connector assembly includes a first connector and a second connector mating with each other in a mating direction, the first connector includes a mating tongue and a plurality of first contacts exposed upon the mating tongue, the second connector includes a mating cavity for receiving the mating tongue therein and a plurality of second contacts for mating with the first contacts. The mating tongue defines an upper long mating face, a lower long mating face opposite to the upper long mating face and extending along a longitudinal direction perpendicular to the mating direction, and a side mating face extending along a vertical direction perpendicular to both the mating direction and the longitudinal direction to connect the upper and lower long mating faces at a longitudinal end thereof. The mating cavity defines a longitudinal upper inner long face for mating with the upper long mating face, a lower inner long face for mating with the lower long mating face, and an inner side face connecting with the upper and lower inner long faces. The mating tongue retains a first inner contact exposed upon the side mating face and a first outer contact surrounding the first inner contact, the mating cavity retains a second inner contact exposed upon the inner side face for mating with the first inner contact and a second outer contact for mating with the first outer contact, and when the first and second connectors mate in the mating direction, the first and second inner contacts connect with each other to be disposed in a shielding frame defined by the first and second outer contacts.

Other objects, advantages and novel features of the invention will become more apparent from the following detailed description of the present embodiment when taken in conjunction with the accompanying drawings.

### BRIEF DESCRIPTION OF THE DRAWINGS

FIG. 1 is a perspective view of an electrical connector assembly including a first connector and a second connector mated with each other in accordance with the present invention;

FIG. 2 is a perspective view of the first connector shown in FIG. 1;

FIG. 3 is a partial exploded perspective view of the first connector shown in FIG. 2;

FIG. 4 is a perspective view of the second connector shown in FIG. 1;

FIG. 5 is a partial exploded perspective view of the second connector shown in FIG. 4;

FIG. 6 is a partial exploded perspective view showing first and second inner contacts and corresponding first and second outer contacts; and

FIG. 7 is a cross-sectional view taken along line 7-7 of FIG. 1.

### DETAILED DESCRIPTION OF THE INVENTION

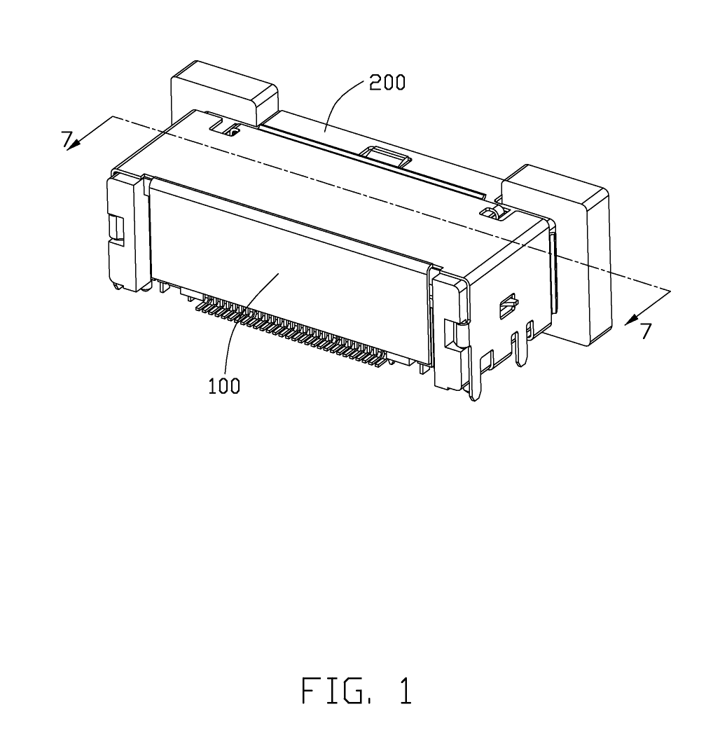

Reference will now be made to the drawing figures to describe a preferred embodiment of the present invention in detail. Referring to FIG. 1, the electrical connector assembly includes a first connector 100 and a second connector 200 mating with each other in a mating direction.

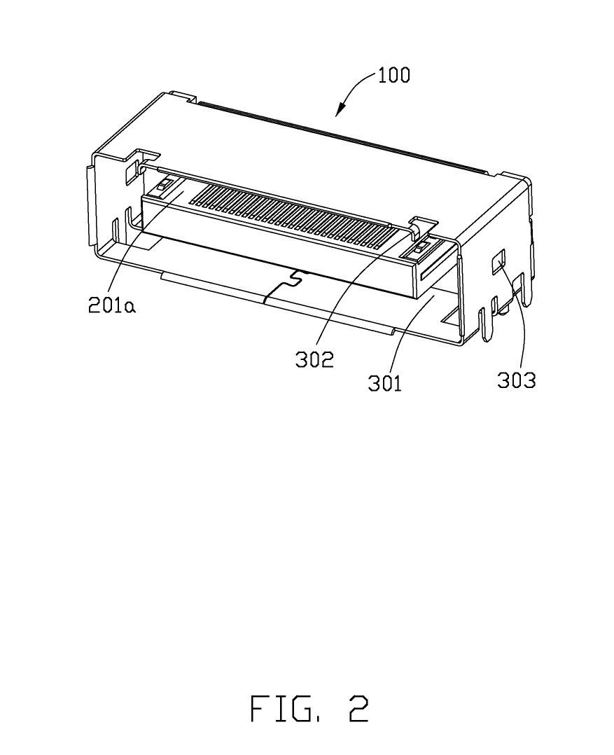

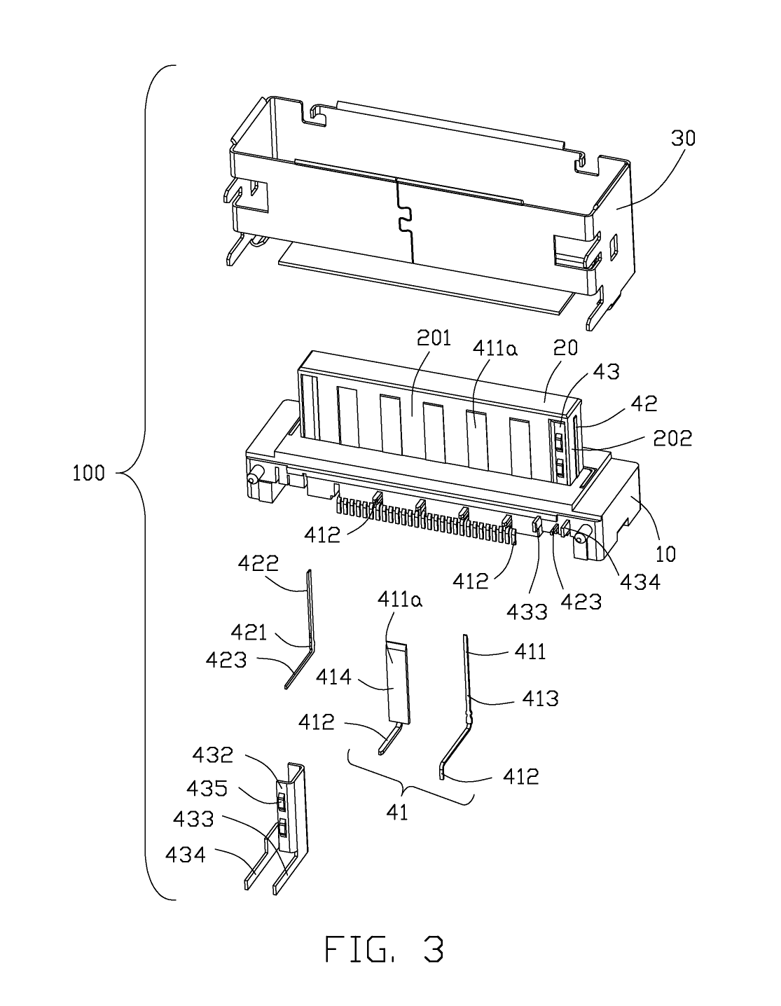

Referring to FIG. 2 and FIG. 3, the first connector 100 includes a longitudinal first base portion 10, a mating tongue 20 extending forwardly from the base portion 10 along the mating direction, and a first metal shell 30 enclosing the mating tongue 20. The mating tongue 20 defines lower and upper long mating faces 201, 201a opposite to each other and extending along a longitudinal direction perpendicular to the mating direction, and a pair of side mating faces 202 extending along a vertical direction perpendicular to both the mating direction and longitudinal direction and each connecting the two long mating faces 201, 201a at a longitudinal end thereof. A plurality of first contacts 41 are exposed upon the two long mating faces 201, 201a, a pair of first outer contacts 43 are respectively retained at two longitudinal ends of the mating tongue 20, and a pair of first inner contacts 42 each exposes upon one of side mating faces 202.

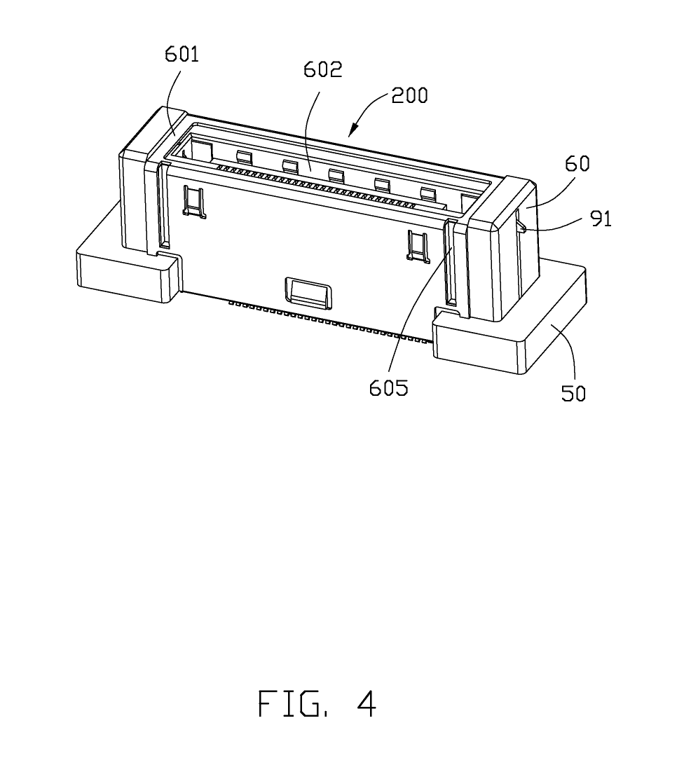

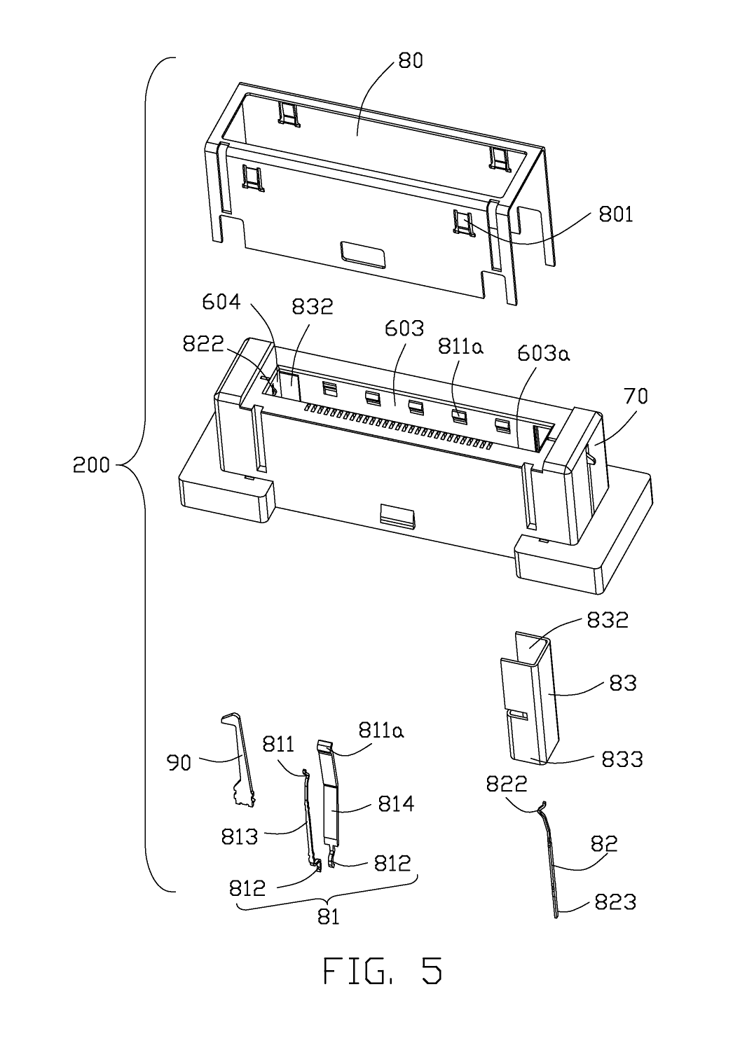

Referring to FIG. 4 and FIG. 5, the second connector 200 defines a longitudinal second base portion 50 and a mating cavity 602 recessed from a front face 601 of a mating portion 60. The mating cavity 602 is surrounded by two opposite longitudinal inner long faces and a pair of inner side faces 604, the two opposite longitudinal inner long faces are defined as an upper inner long face 603a and a lower inner long face 603. A plurality of second contacts 81 are retained in the upper and lower inner long faces 603a, 603, a pair of second inner contacts 82 are respectively retained in the two inner side faces 604. A pair of second outer contacts 83 are retained in the mating portion 60 at two longitudinal ends thereof and exposed at two edges of the second contacts 81.

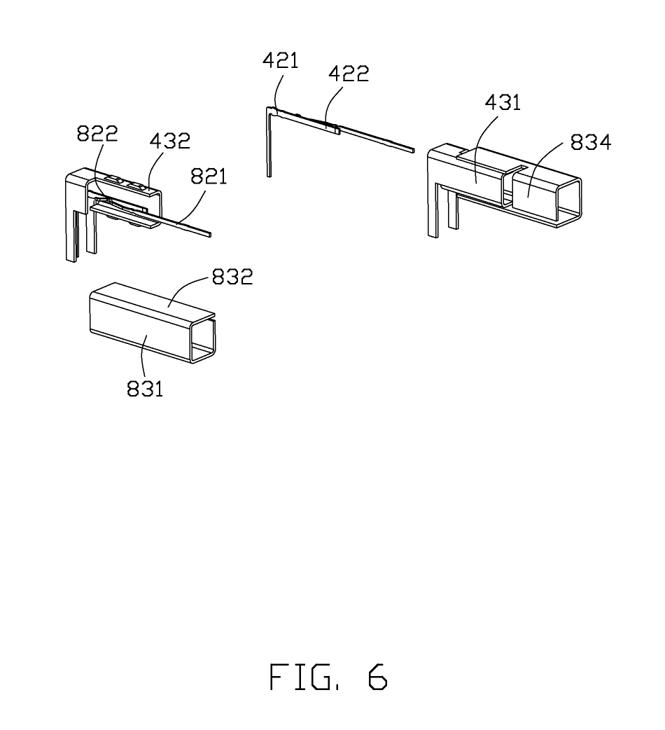

Referring to FIG. 3 and FIG. 6, each first inner contact 42 defines a retaining portion 421, a stiff contacting portion 422 extending from the retaining portion 421 and exposed upon the side mating face 202, and a soldering portion 423 extending out of the first base portion 10. Each first outer contact 43 defines a first connecting portion 431, two bending portions 432 bending toward the side mating face 202 respectively from upper and lower edges of the first connecting portion 431, a first soldering tail 433 downwardly extending from the lower edge of the first connecting portion 431, and a second soldering tail 434 extending outwardly from the bending portion 432 of the upper edge of the first connecting portion 431 and then downwardly extending to parallel with the first soldering tail 433. Each first outer contact 43 is retained at a longitudinal end of the mating tongue 20 with the bending portion 432 extending from the upper edge of the first connecting portion 431 exposed upon the upper long mating face 201a and with the bending portion 432 extending from the lower edge of the first connecting portion 431 exposed upon the lower long mating face 201. The soldering portion 423 of the first inner contact 42 is disposed between the first and second soldering tails 433, 434 of the first outer contact 43. The plurality of first contacts 41 are divided into a set of first signal contacts 413 and a set of first power contacts 414, each first signal contact 413 provides a first touching portion 411 exposed upon the upper long mating face 201a and a soldering leg 412, and each first power contact 414 provides a second touching portion 411a exposed upon the lower long mating face 201 and a soldering leg 412.

Referring to FIG. 5 and FIG. 6, each second inner contact 82 defines a fixing portion 821 retained in the mating portion 60, a resilient contacting arm 822 extending from a front side of the fixing portion 821 and passing through the inner side faces 604 to project into the mating cavity 602, and a soldering leg 823 extending out of the second base portion 50. Each second outer contact 83 defines a second connecting portion 831 retained to the mating portion 60, and two contacting sections 832 respectively bending from upper and lower edges of the second connecting portion 831 and exposed upon upper and lower inner long faces 603a, 603. The second connecting portion 831 and the contacting sections 832 partial extend out of the second base portion 50 to be defined as a soldering section 833. The plurality of second contacts 81 are divided into a set of second signal contacts 813 and a set of second power contacts 814, each second signal contact 813 provides a first touching section 811 exposed upon the upper inner long face 603a, and each second power contact 814 provides a second touching section 811a exposed upon the lower inner long face 603, the plurality of second contacts 81 each provides a connecting section 812 extending out of the second base portion 50.

The first metal shell 30 encloses the mating tongue 20 to define a receiving cavity 301 for receiving the mating portion 60 of the second connector 200 therein. The first metal shell 30 defines a blocking portion 302 split from a front edge thereof to project toward the mating tongue 20, and the mating portion 60 defines a corresponding slot 605 for fitting with the blocking portion 302. The mating portion 60 includes an extending portion 70 enclosed with a second metal shell 80 and a pair of latching arms 90 disposed at two sides of the extending portion 70 with latching portions 91 exposed out of the mating portion 60 for latching with locking windows 303 of the first metal shell, the second metal shell 80 defines elastic latching portion 801 for latching with the first metal shell 30.

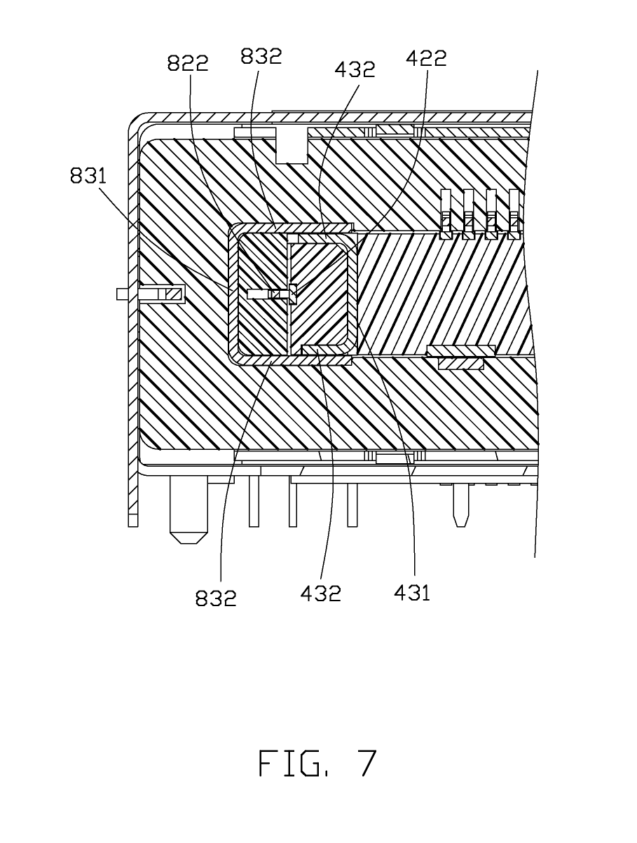

Referring to FIG. 7, when the first and second connectors 100, 200 mate with each other in the mating direction, the blocking portion 302 is received in the slot 605 to guide the mating portion 60 entering into the receiving cavity 301, and the mating tongue 20 enters into the mating cavity 602 to make the first contacts 41 connect with the second contacts 81. The two contacting sections 832 of one second outer contact 83 each contacts with a corresponding bending portion 432 of a first outer contact 43 to form a closed shielding frame, synchronously, the stiff contacting portion 422 of the first inner contact 42 and the resilient contacting arm 822 of the second inner contact 82 dispose in the closed shielding frame to electrically connect with each other for RF (Radio Frequency) signal transmission. A shielding plate 834 provided at each second outer contact 83 is disposed opposite to the second connecting portion 831 to improve the shielding function of the closed shielding frame. Each bending portion 432 of the first outer contact 43 defines two rib portions 435 aligned with each other in the mating direction for contacting with the contacting section 832 of the second outer contact 83.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. An electrical connector assembly comprising:
a first connector and a second connector mating with each other in a mating direction, the first connector comprising:
a mating tongue defining an upper long mating face, a lower long mating face opposite to the upper long mating face and extending along a longitudinal direction perpendicular to the mating direction, and a side mating face extending along a vertical direction perpendicular to both the mating direction and the longitudinal direction to connect the upper and lower long mating faces at a longitudinal end thereof; and
a plurality of first contacts retained in the mating tongue and exposed upon one of the upper and lower long mating face;
the second connector comprising:
a mating cavity for receiving the mating tongue therein and defining a longitudinal upper inner long face for mating with the upper long mating face, a lower inner long face for mating with the lower long mating face, and an inner side face connecting with the upper and lower inner long faces; and
a plurality of second contacts exposed upon one of the upper and lower inner long face for mating with the first contacts;
wherein the mating tongue retains a first inner contact exposed upon the side mating face and a first outer contact surrounding the first inner contact, the mating cavity retains a second inner contact exposed upon the inner side face for mating with the first inner contact and a second outer contact for mating with the first outer contact, and when the first and second connectors mate in the mating direction, the first and second inner contacts connect with each other to be disposed in a shielding frame defined by the first and second outer contacts.

2. The electrical connector assembly as described in claim 1, wherein the first outer contact defines a bending portion exposed upon one of the upper and lower long mating faces and a first connecting portion retained in the mating tongue, the second outer contact defines a second connecting portion and a contacting section bending from an edge of the second connecting portion to be exposed upon one of the upper and lower inner long faces, the bending portion contacts with the corresponding contacting section to define the shielding frame.

3. The electrical connector assembly as described in claim 2, wherein the bending portion of the first outer contact is stiff and defines two rib portions aligned with each other in the mating direction.

4. The electrical connector assembly as described in claim 1, wherein the second outer contact defines a shielding plate opposite to the second connecting portion to improve the shielding function of the shielding frame.

5. The electrical connector assembly as described in claim 1, wherein the first connector comprises a first base portion and a first metal shell retained in the first base portion, the mating tongue extends from the first base portion and is surrounded by the first metal shell to define a receiving cavity, the first metal shell defines a blocking portion split from a front edge thereof to project toward the mating tongue.

6. The electrical connector assembly as described in claim 1, wherein the first and second inner contacts connect with each other in the shielding frame for RF (Radio Frequency) signal transmission.

7. The electrical connector assembly as described in claim 1, wherein the plurality of first contacts are divided into a set of first signal contacts and a set of first power contacts, the set of first signal contacts provide first touching portions exposed upon the upper long mating face, and the set of first power contacts provide second touching portions exposed upon the lower long mating face.

8. The electrical connector assembly as described in claim 1, wherein the plurality of second contacts are divided into a set of second signal contacts and a set of second power contacts, the set of second signal contacts provide first touching sections exposed upon the upper inner long face, and the set of second power contacts provide second touching sections exposed upon the lower inner long face.

9. An electrical connector for mating with a second connector in a mating direction, comprising:
a mating tongue defining upper and lower long mating faces opposite to each other and extending along a longitudinal direction perpendicular to the mating direction, and a side mating face extending along a vertical direction perpendicular to both the mating direction and the longitudinal direction to connect the two long mating faces at a longitudinal end thereof;
a plurality of first contacts retained in the mating tongue and exposed upon one of the upper and lower long mating faces;
wherein the mating tongue further retains a first outer contact and a first inner contact therein, the first inner contact defines a contacting portion exposed upon the side mating face, and the first outer contact defines two bending portions respectively exposed upon the upper and lower long mating faces for mating with a mating element and a first connecting portion connecting with the two bending portions, the first inner contact is disposed among the two bending portions and the first connecting portion to be surrounded on three sides by the first outer contact.

10. The electrical connector as described in claim 9, wherein the first inner contact is disposed closer to the side mating face than that of the first connecting portion disposed.

11. The electrical connector as described in claim 9, wherein each bending portion of the first outer contact defines two rib portions aligned with each other in the mating direction.

12. The electrical connector as described in claim 9, wherein the electrical connector comprises a first base portion and a first metal shell retained in the first base portion, the mating tongue extends from the first base portion and is surrounded by the first metal shell to define a receiving cavity, the first metal shell defines a blocking portion split from a front edge thereof to project toward the mating tongue.

13. The electrical connector as described in claim 9, wherein the plurality of first contacts are divided into a set of first signal contacts and a set of first power contacts, the set of first signal contacts provide first touching portions exposed upon the upper long mating face, and the set of first power contacts provide second touching portions exposed upon the lower long mating face.

14. The electrical connector as described in claim 9, wherein the first outer contact and the first inner contact mate with the mating elements for RF (Radio Frequency) signal transmission.

15. An electrical connector assembly comprising:
a first electrical connector including a first insulative housing defining a rectangular mating port, in a front view, defined by a longitudinal direction and a transverse direction perpendicular to each other, said mating port communicating with an exterior along a front-to-back direction perpendicular to both said longitudinal direction and said transverse direction;
at least one row of first signal contacts disposed in the first housing along said longitudinal direction, each of said first signal contacts extending along the front-to-back direction; and
at least one first RF contact set located around one end of said housing in said longitudinal direction and beside said one row of first contacts, said first RF contact set including a first RF (Radio Frequency) signal contact and a first RF shielding contact located close to said RF signal contact; wherein
the first RF shielding contact cooperates with the first housing to exposed said first RF signal contact in a lateral direction perpendicular to said front-to-back direction for mechanically and electrically connecting to a second RF signal contact of a second electrical connector adapted to mate with the first electrical connector.

16. The electrical connector assembly as claimed in claim 15, wherein said lateral direction is the longitudinal direction.

17. The electrical connector assembly as claimed in claim 15, wherein said first RF shielding contact defines a U-shaped structure viewed along the front-to-back direction so as to efficiently shield the neighboring first RF signal contact on one side opposite to an exposed side of said first RF signal contact.

18. The electrical connector assembly as claimed in claim 15, wherein said first housing forms a mating tongue, said one row of first signal contacts are located on the mating tongue and said first RF contact set is located at an end of the mating tongue in said longitudinal direction, wherein the first RF shielding contact is located between the first RF signal contact and said one row of first signal contacts.

19. The electrical connector assembly as claimed in claim 15, wherein said first housing forms a receiving cavity, said one row of first signal contacts are located on a longitudinal side of the receiving cavity while the first RF signal contact set is located on thereof a transverse side perpendicular to said longitudinal side, and said first RF shielding contact is located on an outer side of said RF signal contact in said longitudinal direction.

20. The electrical connector assembly as claimed in claim 15, wherein the first RF signal contact and the second RF contact are mechanically and electrically connected to each other in said lateral direction, and said second RF signal contact is equipped with a second RF shielding contact which cooperates with the first RF shielding contact to form a complete circumferential shielding with regard to the mated first RF signal contact and second RF signal contact viewed in the front-to-back direction.
